(19) United States
(12) Patent Application Publication
(10) Pub. No.: US 2025/0046342 A1
(43) Pub. Date: Feb. 6, 2025

(54) VIDEO SPECIAL EFFECT PROCESSING METHOD AND APPARATUS, ELECTRONIC DEVICE, AND PROGRAM PRODUCT

(71) Applicant: Beijing Zitiao Network Technology Co., Ltd., Beijing (CN)

(72) Inventors: Dong QIU, Beijing (CN); Sijin LI, Beijing (CN); Yongbo MAO, Beijing (CN); Qing FAN, Beijing (CN)

(21) Appl. No.: 18/717,734

(22) PCT Filed: Nov. 14, 2022
(86) PCT No.: PCT/CN2022/131736

§ 371 Date: Jun. 7, 2024

(30) Foreign Application Priority Data
Dec. 10, 2021 (CN) 202111507334.4

(51) Int. Cl. G11B 27/00; G06T 7/246; G06V 10/74; G06V 20/40; G06V 20/58

(52) U.S. Cl. CPC G11B 27/002; G06T 7/248; G06V 10/761; G06V 20/41; G06V 20/49; G06V 20/58; G06T 2207/10016; G06T 2207/30241; G06T 2207/30252

(57) ABSTRACT

A video effect processing method, apparatus and system, an electronic device, a storage medium, a computer program product, and a computer program provided by embodiments of the present disclosure realize a function of displaying an effect video resulting from a rendering processing of effects by performing, during a driving process of a vehicle, target recognition processing based on at least two algorithms on a captured driving video, and performing target tracking processing on a result of the target recognition processing, so as to perform the rendering processing on the driving video according to an image trajectory of the target to be rendered in the driving video. By doing so, users can view the effect video of the photo-capturing tour while self-driving thus improving the user experience.

### CROSS-REFERENCE TO RELATED APPLICATION(S)

The present disclosure claims priority of the Chinese Patent Application No. 202111507334.4, filed on Dec. 10, 2021, entitled “Video Effect Processing Method and Apparatus, Electronic Device, and Program Product,” the disclosure of which is incorporated herein by reference in its entirety.

### TECHNICAL FIELD

Embodiments of the present disclosure relate to the field of video processing, in particular, to a video effect processing method, apparatus and system, an electronic device, a storage medium, a computer program product, and a computer program.

### BACKGROUND

With the improvement of economic, more and more people prefer to self-driving, and it is possible to take a photo-capturing tour.

In the prior art, the photo-capturing tour is generally implemented based on a mobile terminal or a photographing device. When the photo-capturing is completed, the video is uploaded to a service side for processing including effect processing and the like and displayed. However, such the processing is hysteresis and with poor user experience.

### SUMMARY

In view of the above problems, embodiments of the present disclosure provide a video effect processing method, apparatus and system, an electronic device, a storage medium, a computer program product, and a computer program, which provide users with a better viewing experience by performing real-time capturing and real-time rendering processing of effects of a scene and displaying a processing result during a driving process of a vehicle.

In a first aspect, embodiments of the present disclosure provide a video effect processing method, including:
performing, during a driving process of a vehicle, target recognition processing based on at least two algorithms on a captured driving video, and performing target tracking processing on a result of the target recognition processing, to obtain a target to be rendered of the driving video as well as a corresponding image trajectory; and
performing rendering processing on the driving video according to an image trajectory of the target to be rendered in the driving video, and displaying an effect video resulting from the rendering processing of effects.

In a second aspect, embodiments of the present disclosure provide a video effect processing apparatus, including:
a rendering module, configured to perform, during a driving process of a vehicle, target recognition processing based on at least two algorithms on a captured driving video, and performing target tracking processing on a result of the target recognition processing, to obtain a target to be rendered of the driving video as well as a corresponding image trajectory; and configured to perform rendering processing on the driving video according to an image trajectory of the target to be rendered in the driving video; and
a display module, configured to display an effect video resulting from the rendering processing of effects.

In a third aspect, embodiments of the present disclosure provide a video effect processing system, including:
a vehicle-mounted photographing device, mounted in a driving region of a vehicle, configured to capture a driving video of a vehicle during a driving process; and
a vehicle-mounted display device, mounted in the driving region of the vehicle and/or a seating region of the vehicle, configured to perform rendering processing of effects on the driving video captured by the vehicle-mounted photographing device and display an effect video resulting from the rendering processing of effects, by using the video effect processing method according to the first aspect.

In a fourth aspect, embodiments of the present disclosure provides an electronic device, including: at least one processor; and
a memory;
the memory is configured to store computer-executable instructions;
the at least one processor is configured to execute the computer-executable instructions that stored in the memory, which causes the at least one processor to perform the video effect processing method according to the first aspect.

In a fifth aspect, embodiments of the present disclosure provide a computer-readable storage medium, computer executable instructions are stored on the computer-readable storage medium, and the computer executable instructions, when executed by a processor, implement the video effect processing method according to the first aspect.

In a sixth aspect, embodiments of the present disclosure provide a computer program product, instructions are stored on the computer program product, and the instructions, when executed by a processor, implement the video effect processing method according to the first aspect.

In a seventh aspect, embodiments of the present disclosure provide a computer program, the computer program, when executed by a processor, implements the video effect processing method according to the first aspect.

### BRIEF DESCRIPTION OF DRAWINGS

To describe the technical solutions in the embodiments of the present disclosure or in the prior art more clearly, the accompanying drawings required in the description of the embodiments or the prior art will be described briefly below. Apparently, that drawings in the following description are some embodiments of the present disclosure, and other accompanying drawings can also be derived from these drawings by those ordinarily skilled in the art without creative efforts.

FIG. 1 is a schematic diagram of a scenario application for video effect processing in the prior art;

FIG. 2 is a schematic diagram of a network architecture upon which the present disclosure is based;

FIG. 3 is a flowchart diagram of a video effect processing method provided by embodiments of the present disclosure;

FIG. 4 illustrates a first interface of a video effect processing method provided by embodiments of the present disclosure;

FIG. 5 illustrates a second interface of a video effect processing method provided by embodiments of the present disclosure;

FIG. 6A is a flowchart illustrating recognition tracking processing for video frames provided by embodiments of the present disclosure;

FIG. 6B is a schematic diagram illustrating an effect of a video effect processing method provided by embodiments of the present disclosure;

FIG. 7 is a structural block diagram illustrating a video effect processing apparatus provided by embodiments of the present disclosure;

FIG. 8 is a structural block diagram illustrating a video effect processing system provided by embodiments of the present disclosure; and

FIG. 9 is a schematic diagram of a hardware structure of an electronic device provided by embodiments of the present disclosure.

### DETAILED DESCRIPTION

In order to make the purpose, technical solutions and advantages of the embodiments of the present disclosure clearer, the technical solutions in the embodiments of the present disclosure will be clearly and completely described below with reference to the drawings in the embodiments of the present disclosure. Obviously, the described embodiments are only some, but not all, of the embodiments of the present disclosure. Based on the embodiments of the present disclosure, all other embodiments obtained by those skilled in the art without any creative efforts shall fall within the scope of protection of the present disclosure.

With the improvement of economic, more and more people prefer to self-driving, and it is possible to take a photo-capturing tour.

In the prior art, the photo-capturing tour is generally implemented based on a mobile terminal or a photographing device. When the photo-capturing is completed, the video is uploaded to a service side for processing including effect processing and the like and displayed.

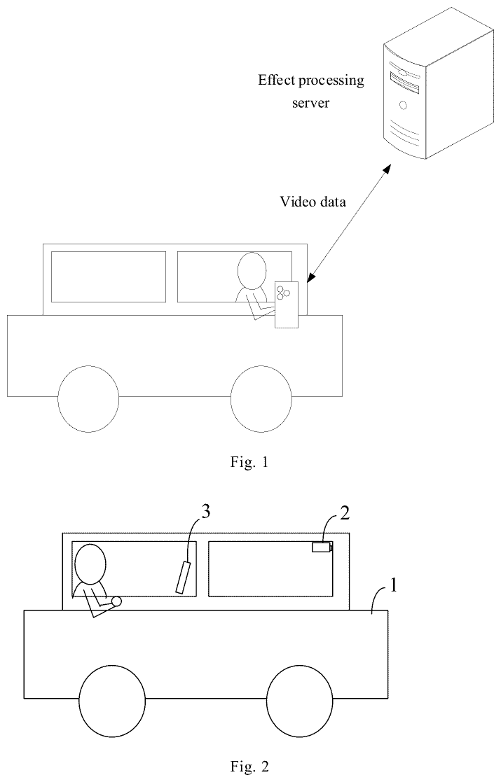

Illustratively, FIG. 1 is a schematic diagram of a scenario application for video effect processing in the prior art. As shown in FIG. 1, in this scenario, a user takes a picture of the landscape during a driving process of a vehicle through a handheld mobile device.

After capturing, the user may upload the driving video from the mobile device over the network to an effect processing server in the cloud, which processes the driving video using effect processing algorithms and returns the processed effect video to the mobile device for the user to browse.

However, it is clear that for the scenario shown in FIG. 1, the existing processing method for driving video requires, on the one hand, multiple operations such as uploading and downloading video data, and the effect processing is cumbersome; on the other hand, the existing video capturing and video effect processing is performed in steps, and the hysteresis is strong for the display of the video effect, and the user experience is poor.

In view of such a problem, embodiments according to the present disclosure may provide a vehicle-mounted display device, which may be used to perform rendering processing of effects on the driving video on the vehicle, so that a locally-based real-time rendering processing of effects may be performed on a currently captured driving video during the driving process of the vehicle, and the effect video obtained by the rendering processing of effects may be displayed in real time. In this way, on the one hand, the operation process of browsing the effect video by the user can be simplified, and on the other hand, the speed of the rendering processing of effects for the driving video can be effectively improved, so that the user watches the effect video corresponding to the current driving video in real time during the driving process of the vehicle, thus improving the user experience.

The video effect processing method, apparatus and system, the electronic device, the storage medium, the computer program product, and the computer program provided by the embodiments of the present disclosure realize a function of displaying an effect video resulting from a rendering processing of effects by performing, during a driving process of a vehicle, target recognition processing based on at least two algorithms on a captured driving video, and performing target tracking processing on a result of the target recognition processing, so as to perform the rendering processing on the driving video according to an image trajectory of the target to be rendered in the driving video. By doing so, users can view the effect video of the photo-capturing tour while self-driving thus improving the user experience.

Referring to FIG. 2, which is a schematic diagram of a network architecture upon which the present disclosure is based, the network architecture shown in FIG. 2 may specifically include a vehicle 1, a vehicle-mounted photographing device 2, and a vehicle-mounted display device 3.

The vehicle-mounted photographing device 2 specifically may be a hardware device, such as a driving recorder, a video capturing device, an image capturing device, or the like, that can be used for photographing and capturing landscapes along the way in the driving process of the vehicle.

The vehicle-mounted display device 3 may be specifically a hardware device having an arithmetic processing function and a display function, and through the connection with the vehicle-mounted photographing device 2, it may be used to acquire the driving video photographed by the vehicle-mounted photographing device 2 in real time and perform rendering processing of effects on the driving video in real time, and use its display function to display the processed effect video in real time.

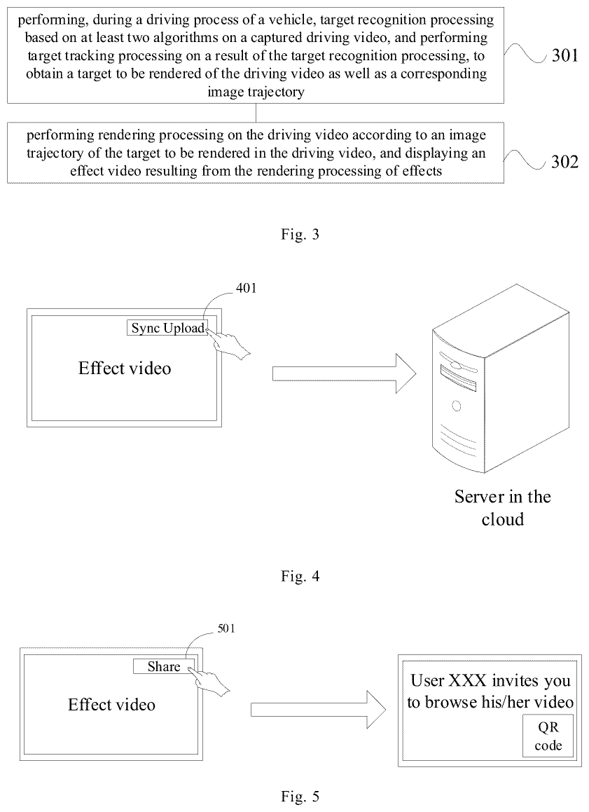

Based on the aforementioned network architecture, in a first aspect, referring to FIG. 3, which is a flowchart diagram of a video effect processing method provided by embodiments of the present disclosure.

The video effect processing method provided by embodiments of the present disclosure includes:
Step 301: performing, during a driving process of a vehicle, target recognition processing based on at least two algorithms on a captured driving video, and performing target tracking processing on a result of the target recognition processing, to obtain a target to be rendered of the driving video as well as a corresponding image trajectory;
Step 302: performing rendering processing on the driving video according to an image trajectory of the target to be rendered in the driving video, and displaying an effect video resulting from the rendering processing of effects.

It is to be noted that the video effect processing method provided in this embodiment is performed as a vehicle-mounted video effect processing apparatus, which is generally integrated in a video effect processing system.

As shown in connection with FIG. 2 and FIG. 3, the vehicle-mounted

photographing device mounted in a driving region of a vehicle is included in the video effect processing system for capturing the driving video of the vehicle during the driving process. For example, the vehicle-mounted photographing device may specifically be a driving recorder mounted in the cab for photographing the driving process of the vehicle with the vehicle as the first viewing angle. The video effect processing system further includes a vehicle-mounted display device in which the aforementioned video effect processing apparatus is integrated, which may specifically be a center control display device mounted in a front driving region of the vehicle or a controllable display device mounted in a rear seating region of the vehicle.

When the vehicle-mounted photographing device is started and the driving video of the vehicle during the driving process is captured, the driving video may be transmitted to the vehicle-mounted display device in real time, and at this time, the video effect processing apparatus in the vehicle-mounted display device may perform video effect processing based on the aforementioned steps 301 and 302, and display the processing result on the vehicle-mounted display device in real time for the user to browse.

Compared with the prior art, the localization of the video effect processing saves the operation process of uploading and downloading by the user, so as to simplify the operation process of browsing the effect video by the user; in addition, the localization of the video effect process can effectively improve the speed of the rendering processing of effects for the driving video, so that the user watches the effect video corresponding to the current driving video in real time during the driving process of the vehicle, thus improving the user experience.

Optionally, in embodiments of the present disclosure, relevant video data obtained during the driving process may also be uploaded synchronously into the cloud for subsequent viewing and use by the user.

In particular, the video effect processing apparatus may upload the driving video and/or the effect video to the cloud for storage in response to a first operation triggered by the user. FIG. 4 illustrates a first interface diagram of a video effect processing method provided by embodiments of the present disclosure. When the video effect processing apparatus displays the effect video of the rendering processing of effects, a user may trigger a first operation by clicking a “Sync Upload” button 401. At this point, the video effect processing apparatus synchronously uploads the currently captured driving video and/or the currently generated effect video to a server in the cloud for storage.

For example, in the server, the driving video captured by the video effect processing apparatus may be stored to perform rendering processing of effects, so that a plurality of effect videos can be obtained. While storing the video data of each effect video, relevant information such as the generation time of the effect video, the generation location of the effect video (vehicle driving trajectory), and vehicle model can be stored synchronously for subsequent viewing and use by the user.

By storing effect video based on “cloud” storage, the video effect processing apparatus does not need to store driving videos and effect videos generated during historical driving processes, thereby effectively saving storage resources of the video effect processing apparatus, and facilitating a lightweight configuration of the video effect processing system.

Optionally, in embodiments of the present disclosure, the effect video may also be shared to other users to further enhance the user experience.

In particular, the video effect processing apparatus transmits the effect video to other users in response to a second operation triggered by the user. In FIG. 5, which is a second interface diagram of a video effect processing method provided by embodiments of the present disclosure, the user may trigger the second operation by clicking a “Share” button 501 while the video effect processing apparatus displays the effect video after the rendering processing of effects. At this time, as shown in the right panel of FIG. 5, other users receive the sharing information transmitted from the video effect processing apparatus, through which the other users can synchronously browse the effect video.

The sharing information may be a plurality of types of sharing information. Exemplary, the sharing information may be an address link or a picture QR code, and other users may browse the effect video by clicking on the address link or scanning the picture QR code.

By such sharing of the effect video, it is possible to invite other users to view the effect video together on the basis of himself/herself watching the effect video during the driving process, thus giving the effect video more social attributes and improving the user experience.

In view of the high time-efficiency requirement when performing real-time rendering processing of effects on the driving video, and in order to be able to perform fast video effect rendering processing on the driving video, on the basis of the above embodiments, the present implementation also adopts at least two kinds of target recognition algorithms including an optical flow prediction algorithm and a target detection algorithm to realize target recognition on the driving video to guarantee that corresponding rendering processing of effects can be performed later.

In the rendering processing of effects described above, a target recognition processing mode in which the optical flow prediction algorithm and the target detection algorithm are alternated is introduced in embodiments of the present disclosure to improve processing speed, and it is also combined with Intersection over Union (IOU) matching and cascade matching to improve tracking efficiency, thereby satisfying processing demands for real-time processing of the driving video.

Specifically, the driving video includes a plurality of video frames in succession, and performing the target recognition processing based on the at least two algorithms on the captured driving video, and performing the target tracking processing on the result of the target recognition processing, to obtain the target to be rendered of the driving video as well as the corresponding image trajectory, includes:
Step 4011: adopting, according to a frame number of the current video frame, a target recognition processing algorithm corresponding to the frame number to perform target recognition on the current video frame of the driving video, to obtain a target recognition box of the current video frame.

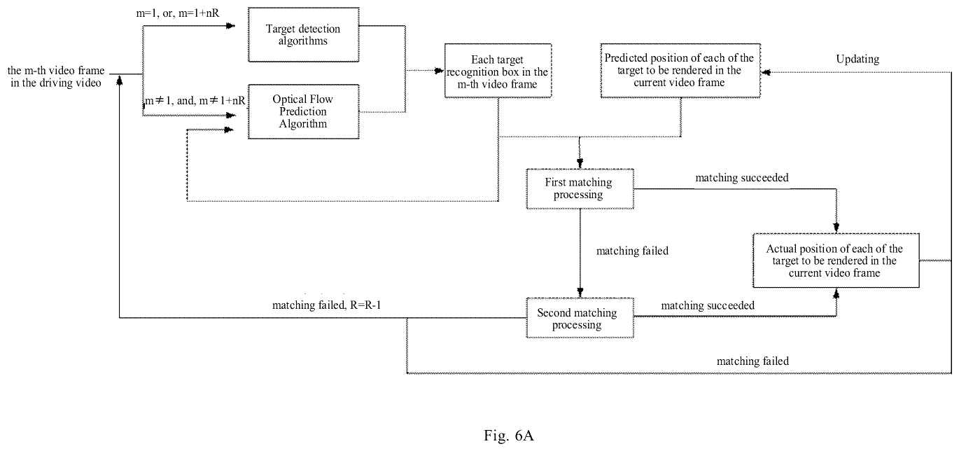

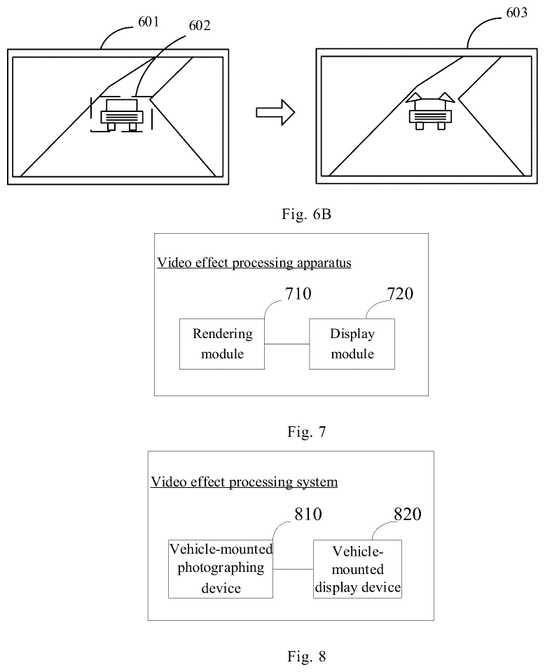

FIG. 6A is a flowchart illustrating recognition tracking processing of video frames provided by embodiments of the present disclosure. In connection with step 4011 and FIG. 6A, the following video includes M frequency frames in succession as an example. Unlike the target recognition technology in prior art, the present embodiments do not use a single algorithm for processing video frames, but uses an R-based dynamic algorithm for determining a target recognition box for each video frame.

For the algorithm, the detection accuracy of the target detection algorithm is higher but less efficient, whereas the detection efficiency of the optical flow prediction algorithm is very high but less accurate. Considering the characteristics of different algorithms, the R-based interval invocation mode is employed in the present embodiments to invoke different algorithms for different video frames to perform the detection and output of the target recognition box.

Optionally, which algorithm to use for target recognition is determined according to the frame number of the video frame:

Assuming that the current video frame is the m-th frame of the m video frames in succession, in response to m=1 (i.e., the 1st frame), or m≠1+nR (i.e., the (1+nR)-th frame), the video effect processing apparatus invokes the target detection algorithm to perform target recognition processing on the m-th frame of the current video frame to recognize the target recognition box in the m-th frame; in response to m≠1 (i.e., non-1 st frame), and m≠1+nR (i.e., non-(1+nR)-th frame), the video effect processing apparatus invokes the optical flow prediction algorithm to perform the target recognition processing on the m-th frame of the current video frame to identify the target recognition box in the m-th frame; where n and R are both positive integers and R is a frame interval coefficient.

It is known that the optical flow prediction algorithm specifically includes performing sparse optical flow prediction on a position in the current video frame of a target recognition box in a video frame previous to the current video frame, to obtain the target recognition box of the current video frame. That is, the accuracy of the target recognition box obtained by the optical flow prediction algorithm depends to some extent on the accuracy of the target recognition box in the previous frame. Based on this, the present embodiments adopt to invoke the target detection algorithm once every R frame to perform the detection of the target recognition box with higher accuracy on the video frame, to guarantee accuracy while improving detection efficiency of the target recognition box.

Of course, it needs to be explained that, in the process of performing the target recognition processing with at least two algorithms, the number of target recognition boxes obtained by each algorithm that perform the processing on the video frame is uncertain, that is, the number of target recognition boxes may be one or more, and the implementation of the present disclosure does not limit the number of target recognition boxes thereof.

Step 4012: predicting an actual position of the target to be rendered in the current video frame according to a historical image trajectory of each of the target to be rendered in the driving video, to obtain a predicted position of the target to be rendered in the current video frame.

Step 4013: performing matching processing on the target recognition box of the current video frame and the predicted position of the target to be rendered in the current video frame, and obtaining the actual position of the target to be rendered in the current video frame according to a result of the matching processing.

As can be seen from the combination of the steps 4012 and 4013, after the determination of the target recognition box of the m-th frame is completed, the video effect processing apparatus performs the matching processing of the target recognition box and the predicted position on each target recognition box of the m-th frame and each predicted position of the target to be rendered in the m-th frame, to determine the actual position of each target to be rendered in the m-th frame.

In the present embodiment, the matching processing is implemented based on two matching algorithms: firstly, performing a first matching processing, i.e., IOU matching, based on a degree of spatial overlap on each target recognition box of the current video frame and each predicted position of the target to be rendered in the current video frame; secondly, performing a second matching processing, i.e., cascade matching, based on feature similarity on each target recognition box of the current video frame and each predicted position of the target to be rendered in the current video frame.

Specifically, as shown in FIG. 6A, the target recognition box of the m-th frame and the predicted position of the target to be rendered in the m-th frame are subjected to IOU matching based on the degree of spatial overlap; in response to the processing result of the matching processing being matched, determining the actual position of the target to be rendered in the m-th frame based on the matching result; in response to the processing result of the matching processing being not matched, the target recognition box of the m-th frame and the predicted position of the target to be rendered at the m-th frame are subjected to the feature similarity-based cascade matching processing, and then the actual position of the target to be rendered in the m-th frame is determined based on the result of the cascade matching processing.

As can be seen, the calculation amount of IOU matching is small and its processing efficiency is extremely high, while cascade matching processing has better matching effect on occlusion problems. By firstly using the IOU matching and then the cascade matching processing, the matching efficiency can be improved while the matching accuracy can be guaranteed.

Further, it should be noted that the predicted position of the target to be rendered in the m-th frame is predicted based on the historical image trajectory of the target to be rendered in the driving video, and in general, the number of the target to be rendered is not fixed, and it may be one or more.

Exemplarily, the predicted position of each target to be rendered in each video frame of the driving video is predicted by using the Kalman filter, and the actual position of each obtained video frame is calculated according to the video effect processing apparatus, and the predicted position of each video frame is updated to ensure reliability of the predicted position.

For example, when processing the m-th frame, the actual position of each of the target to be rendered in the 1st frame to the (m-1)-th frame is already calculated, at this time, the Kalman filter predicts the position of each of the target to be rendered in the m-th frame to the M-th frame according to the actual position of each of the target to be rendered in the 1 st frame to the (m-1)-th frame, and obtains the predicted position of each of the target to be rendered in the m-th frame to the M-th frame, respectively. And in response to the processing of the m-th frame being completed, the actual position of each of the target to be rendered in the m-th frame is obtained; the Kalman filter uses the actual position of each target to be rendered in the m-th frame to update the previously obtained predicted position of each target to be rendered in the m-th frame, and re-predicts the position of each of the target to be rendered in the (m+1)-th frame to the M-th frame. By such iterative prediction, it is ensured that the predicted position of each of the target to be rendered for each use is time-efficient.

On the basis of the above implementation, in an alternative embodiment, the frame interval coefficient R may be a dynamically adjusted value, and the value of the frame interval coefficient R is adjusted for the result of the matching processing obtained by performing the matching processing on the target recognition box of the current video frame and the predicted position of the target to be rendered in the current video frame.

As shown in connection with FIG. 6A, when each target recognition box of the m-th video frame fails to match each target to be rendered at the predicted position in each video frame twice, it is explained that, compared with the previous video frame, a new target to be rendered may appear in the m-th video frame, or the target to be rendered may disappear from the m-th video frame.

In this regard, on the one hand, in order to improve the recognition stability, the target detection algorithm with higher accuracy needs to be used to process the subsequent video frames to improve the recognition accuracy of the video as soon as possible, i.e., the value of R can be lowered, such as R=R−1; on the other hand, the predicted position of the target to be rendered in the video frame also needs to be updated to improve matching efficiency for subsequent video frames.

After completing the above processing of the current video frame, the video effect processing apparatus invokes a video effect rendering algorithm to process the target to be rendered in the driving video, to obtain the effect video. For the video effect rendering algorithm, the video effect processing apparatus may invoke the corresponding video effect rendering algorithm from the algorithm library based on the effect component selected by the user. Further, when processing each of the target to be rendered, the effect image may be superimposed to each actual position of each target image to be rendered in the image trajectory of the driving video to generate the effect video.

The image trajectory of each target image to be rendered in the driving video is constituted by the actual position of each of the target to be rendered in each video frame, exemplarily, the image trajectory is denoted as [target x, Pxm], where Pxm is used to denote the actual position of target x in the m-th video frame. For example, for target A, its image trajectory may be represented as [target A, PA1, PA2].

Based on this, during the effect processing, the effect image of the target x in the m-th video frame may be superimposed to the actual position Pxm of the target x in the m-th video frame to generate the effect frame image of the m-th video frame in the driving video, while the effect frame images of the M video frames are concatenated to obtain the effect video.

FIG. 6B is a schematic diagram illustrating an effect of a video effect processing method provided by embodiments of the present disclosure. As shown in FIG. 6B, interface 601 is a presentation interface of a driving video, a box 602 selects the actual position of a vehicle to be rendered, which is processed by effect rendering, to obtain a presentation interface of an effect video as shown in interface 603.

The video effect processing method according to the embodiments of the present disclosure performs real-time rendering processing of effects on the captured driving video during the driving process of the vehicle and displays the effect video after the rendering processing of effects, thereby allowing the user to view the effect video of the photo-capturing tour while self-driving, and thus improving the user experience.

In a second aspect, corresponding to the video effect processing method according to the above embodiments, FIG. 7 is a structural block diagram of a video effect processing apparatus provided by embodiments of the present disclosure. For convenience of explanation, only parts related to the embodiments of the present disclosure are shown. Referring to FIG. 7, the video effect processing apparatus includes:
a rendering module 710, configured to perform, during a driving process of a vehicle, target recognition processing based on at least two algorithms on a captured driving video, and performing target tracking processing on a result of the target recognition processing, to obtain a target to be rendered of the driving video as well as a corresponding image trajectory; and configured to perform rendering processing on the driving video according to an image trajectory of the target to be rendered in the driving video;
a display module 720, configured to display an effect video resulting from the rendering processing of effects.

In an alternative embodiment, the driving video includes a plurality of video frames in succession;
the rendering module 710, specifically configured to: adopt, according to a frame number of the current video frame, a target recognition processing algorithm corresponding to the frame number to perform target recognition on the current video frame of the driving video, to obtain a target recognition box of the current video frame; predict an actual position of the target to be rendered in the current video frame according to a historical image trajectory of each of the target to be rendered in the driving video, to obtain a predicted position of the target to be rendered in the current video frame; and perform matching processing on the target recognition box of the current video frame and the predicted position of the target to be rendered in the current video frame, and obtain the actual position of the target to be rendered in the current video frame according to a result of the matching processing.

In an alternative embodiment, the rendering module 710 is specifically configured to: in response to the current video frame being a 1st frame in the driving video, or the current video frame is a (1+nR)-th frame in the driving video, invoking a target detection algorithm to perform the target recognition processing on the current video frame to obtain the target recognition box of the current video frame; n and R are both positive integers, and R is a frame interval coefficient.

In an alternative embodiment, the rendering module 710 is specifically configured to: in response to the current video frame being not a 1st frame of the driving video and the current video frame is not a (1+nR)-th frame in the driving video, invoking an optical flow prediction algorithm to perform the target recognition processing on the current video frame to obtain the target recognition box of the current video frame; n and R are both positive integers, and R is a frame interval coefficient.

In an alternative embodiment, the rendering module 710 is configured to perform sparse optical flow prediction on a position in the current video frame of a target recognition box in a video frame previous to the current video frame, to obtain the target recognition box of the current video frame.

In an alternative embodiment, the rendering module 710 is further configured to adjust the value of the frame interval coefficient R for a result of the matching processing obtained by performing the matching processing on the target recognition box of the current video frame and the predicted position of the target to be rendered in the current video frame.

In an alternative embodiment, the rendering module 710 is specifically configured to: perform a first matching processing based on a degree of spatial overlap on the target recognition box of the current video frame and the predicted position of the target to be rendered in the current video frame; in response to a processing result of the first matching processing being matched, taking the processing result of the first matching processing as the result of the matching processing; in response to the processing result of the first matching processing being not matched, performing a second matching processing based on feature similarity on the target recognition box of the current video frame and the predicted position of the target to be rendered in the current video frame, and taking a processing result of the second matching processing as the result of the matching processing.

In an alternative embodiment, the rendering module 710 is further configured to invoke a video effect rendering algorithm to process the target to be rendered in the driving video, to obtain the effect video.

In an alternative embodiment, the video effect processing apparatus further includes: an interaction module;
the interaction module configured to upload the driving video and/or the effect video to cloud for storage in response to a first operation triggered by a user.

In an alternative embodiment, the video effect processing apparatus further includes: an interaction module;
the interaction module configured to transmit the effect video to other users in response to a second operation triggered by a user.

The video effect processing apparatus provided by the embodiments of the present disclosure performs real-time rendering processing of effects on the captured driving video during the driving process of the vehicle and displays the effect video after the rendering processing of effects, thereby allowing the user to view the effect video of the photo-capturing tour while self-driving, and thus improving the user experience.

In a third aspect, corresponding to the video effect processing method according to the above embodiments, FIG. 8 is a structural block diagram of a video effect processing system provided by embodiments of the present disclosure. For convenience of explanation, only parts related to the embodiments of the present disclosure are shown. Referring to FIG. 8, a video effect processing system includes:
a vehicle-mounted photographing device 810 mounted in a driving region of a vehicle, configured to capture a driving video of a vehicle during a driving process; and
a vehicle-mounted display device 820 mounted in the driving region of the vehicle and/or a seating region of the vehicle, configured to perform rendering processing of effects on the driving video captured by the vehicle-mounted photographing device and display an effect video resulting from the rendering processing of effects, by using the aforementioned video effect processing method.

The electronic device provided by the present embodiment, which can be used to perform the technical solutions of the above method embodiments, its implementation principle and technical effect are similar, and the present embodiment will not be described here in detail.

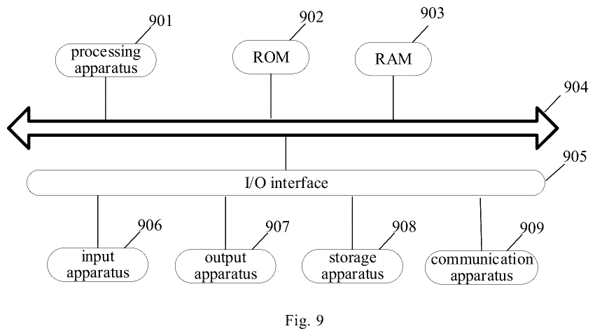

FIG. 9 is specifically referred below, and it shows the structure schematic diagram suitable for achieving the electronic device 900 in the embodiment of the present disclosure. The electronic device 900 in the embodiment of the present disclosure may include but not be limited to a mobile terminal such as a mobile phone, a notebook computer, a digital broadcasting receiver, a personal digital assistant (PDA), a PAD (tablet computer), a portable multimedia player (PMP), a vehicle terminal (such as a vehicle navigation terminal), and a fixed terminal such as a digital television (TV) and a desktop computer. The electronic device shown in FIG. 9 is only an example and should not impose any limitations on the functions and use scopes of the embodiments of the present disclosure.

As shown in FIG. 9, the electronic device 900 may include a processing apparatus (such as a central processing unit, and a graphics processor) 901, it may execute various appropriate actions and processes according to a program stored in a read-only memory (ROM) 902 or a program loaded from a storage apparatus 908 to a random access memory (RAM) 903. In RAM 903, various programs and data required for operations of the electronic device 900 are also stored. The processing apparatus 901, ROM 902, and RAM 903 are connected to each other by a bus 904. An input/output (I/O) interface 905 is also connected to the bus 904.

Typically, the following apparatuses may be connected to the I/O interface 905: an input apparatus 906 such as a touch screen, a touchpad, a keyboard, a mouse, a camera, a microphone, an accelerometer, and a gyroscope; an output apparatus 907 such as a liquid crystal display (LCD), a loudspeaker, and a vibrator; a storage apparatus 908 such as a magnetic tape, and a hard disk drive; and a communication apparatus 909. The communication apparatus 909 may allow the electronic device 900 to wireless-communicate or wire-communicate with other devices so as to exchange data. Although FIG. 9 shows the electronic device 900 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 909, or installed from the storage apparatus 908, or installed from ROM 902. When the computer program is executed by the processing apparatus 901, the above functions defined in the sight line tracking method in the embodiments of the present disclosure are executed.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

The above-mentioned computer-readable medium may be included in the above-mentioned electronic device; it may also be present separately and not incorporated into the electronic device.

The above-mentioned computer-readable medium carries one or more programs which, when executed by the electronic device, cause the electronic device to perform the methods shown in the above-mentioned embodiments.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In response to involving the remote computer, the remote computer may be connected to the user's computer by any types of networks, including LAN or WAN, or may be connected to an external computer (such as connected by using an internet service provider through the Internet).

The present embodiment provides a computer program product, instructions are stored on the computer program product, and the instructions, when executed by a processor, implement the aforementioned method, of which implementation principles and technical effects are similar, which are not described in detail in the present embodiment.

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The involved units described in the embodiments of the present disclosure may be achieved by a mode of software, or may be achieved by a mode of hardware. Herein, the name of the unit does not constitute a limitation for the unit itself in some situations.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

The following are some embodiments of the present disclosure.

In a first aspect, one or more embodiments of the present disclosure provide a video effect processing method, including:
performing, during a driving process of a vehicle, target recognition processing based on at least two algorithms on a captured driving video, and performing target tracking processing on a result of the target recognition processing, to obtain a target to be rendered of the driving video as well as a corresponding image trajectory; and
performing rendering processing on the driving video according to an image trajectory of the target to be rendered in the driving video, and displaying an effect video resulting from the rendering processing of effects.

In an alternative embodiment, the driving video includes a plurality of video frames in succession;
performing the target recognition processing based on the at least two algorithms on the captured driving video, and performing the target tracking processing on the result of the target recognition processing, to obtain the target to be rendered of the driving video as well as the corresponding image trajectory, includes:
adopting, according to a frame number of the current video frame, a target recognition processing algorithm corresponding to the frame number to perform target recognition on the current video frame of the driving video, to obtain a target recognition box of the current video frame;
predicting an actual position of the target to be rendered in the current video frame according to a historical image trajectory of each of the target to be rendered in the driving video, to obtain a predicted position of the target to be rendered in the current video frame; and
performing matching processing on the target recognition box of the current video frame and the predicted position of the target to be rendered in the current video frame, and obtaining the actual position of the target to be rendered in the current video frame according to a result of the matching processing.

In an alternative embodiment, adopting, according to the frame number of the current video frame, the target recognition processing algorithm corresponding to the frame number to perform the target recognition on the current video frame of the driving video, to obtain the target recognition box of the current video frame, includes:
in response to the current video frame being a 1st frame in the driving video, or the current video frame is a (1+nR)-th frame in the driving video, invoking a target detection algorithm to perform the target recognition processing on the current video frame to obtain the target recognition box of the current video frame;
n and R are both positive integers, and R is a frame interval coefficient.

In an alternative embodiment, adopting, according to the frame number of the current video frame, the target recognition processing algorithm corresponding to the frame number to perform the target recognition on the current video frame of the driving video, to obtain the target recognition box of the current video frame, includes:
in response to the current video frame being not a 1st frame of the driving video and the current video frame is not a (1+nR)-th frame in the driving video, invoking an optical flow prediction algorithm to perform the target recognition processing on the current video frame to obtain the target recognition box of the current video frame;
n and R are both positive integers, and R is a frame interval coefficient.

In an alternative embodiment, invoking the optical flow prediction algorithm to perform the target recognition processing on the current video frame to obtain the target recognition box of the current video frame, includes:
performing sparse optical flow prediction on a position in the current video frame of a target recognition box in a video frame previous to the current video frame, to obtain the target recognition box of the current video frame.

In an alternative embodiment, the method further includes:
adjusting a value of R for a result of the matching processing obtained by performing the matching processing on the target recognition box of the current video frame and the predicted position of the target to be rendered in the current video frame.

In an alternative embodiment, performing the matching processing on the target recognition box of the current video frame and the predicted position of the target to be rendered in the current video frame, includes:
performing a first matching processing based on a degree of spatial overlap on the target recognition box of the current video frame and the predicted position of the target to be rendered in the current video frame;
in response to a processing result of the first matching processing being matched, taking the processing result of the first matching processing as the result of the matching processing;
in response to the processing result of the first matching processing being not matched, performing a second matching processing based on feature similarity on the target recognition box of the current video frame and the predicted position of the target to be rendered in the current video frame, and taking a processing result of the second matching processing as the result of the matching processing.

In an alternative embodiment, performing the rendering processing on the driving video according to the image trajectory of the target to be rendered in the driving video, includes:
invoking a video effect rendering algorithm to process the target to be rendered in the driving video, to obtain the effect video.

In an alternative embodiment, the method further includes:
uploading the driving video and/or the effect video to cloud for storage in response to a first operation triggered by a user.

In an alternative embodiment, the method further includes:
transmitting the effect video to other users in response to a second operation triggered by a user.

In a second aspect, one or more embodiments of the present disclosure provide a video effect processing apparatus, including:
a rendering module, configured to perform, during a driving process of a vehicle, target recognition processing based on at least two algorithms on a captured driving video, and performing target tracking processing on a result of the target recognition processing, to obtain a target to be rendered of the driving video as well as a corresponding image trajectory; and configured to perform rendering processing on the driving video according to an image trajectory of the target to be rendered in the driving video; and
a display module, configured to display an effect video resulting from the rendering processing of effects.

In an alternative embodiment, the driving video includes a plurality of video frames in succession;
the rendering module specifically configured to: adopt, according to a frame number of the current video frame, a target recognition processing algorithm corresponding to the frame number to perform target recognition on the current video frame of the driving video, to obtain a target recognition box of the current video frame; predict an actual position of the target to be rendered in the current video frame according to a historical image trajectory of each of the target to be rendered in the driving video, to obtain a predicted position of the target to be rendered in the current video frame; and perform matching processing on the target recognition box of the current video frame and the predicted position of the target to be rendered in the current video frame, and obtain the actual position of the target to be rendered in the current video frame according to a result of the matching processing.

In an alternative embodiment, the rendering module is specifically configured to: in response to the current video frame being a 1st frame in the driving video, or the current video frame is a (1+nR)-th frame in the driving video, invoking a target detection algorithm to perform the target recognition processing on the current video frame to obtain the target recognition box of the current video frame; n and R are both positive integers, and R is a frame interval coefficient.

In an alternative embodiment, the rendering module is configured to: in response to the current video frame being not a 1st frame of the driving video and the current video frame is not a (1+nR)-th frame in the driving video, invoking an optical flow prediction algorithm to perform the target recognition processing on the current video frame to obtain the target recognition box of the current video frame; n and R are both positive integers, and R is a frame interval coefficient.

In an alternative embodiment, the rendering module is configured to perform sparse optical flow prediction on a position in the current video frame of a target recognition box in a video frame previous to the current video frame, to obtain the target recognition box of the current video frame.

In an alternative embodiment, the rendering module is further configured to adjust the value of the frame interval coefficient R for a result of the matching processing obtained by performing the matching processing on the target recognition box of the current video frame and the predicted position of the target to be rendered in the current video frame.

In an alternative embodiment, the rendering module is specifically configured to: perform a first matching processing based on a degree of spatial overlap on the target recognition box of the current video frame and the predicted position of the target to be rendered in the current video frame; in response to a processing result of the first matching processing being matched, taking the processing result of the first matching processing as the result of the matching processing; in response to the processing result of the first matching processing being not matched, performing a second matching processing based on feature similarity on the target recognition box of the current video frame and the predicted position of the target to be rendered in the current video frame, and taking a processing result of the second matching processing as the result of the matching processing.

In an alternative embodiment, the rendering module is further configured to invoke a video effect rendering algorithm to process the target to be rendered in the driving video, to obtain the effect video.

In an alternative embodiment, the video effect processing apparatus further includes: an interaction module;
the interaction module configured to upload the driving video and/or the effect video to cloud for storage in response to a first operation triggered by a user.

In an alternative embodiment, the video effect processing apparatus further includes: an interaction module;
the interaction module configured to transmit the effect video to other users in response to a second operation triggered by a user.

In a third aspect, one or more embodiments of the present disclosure provide a video effect processing system, including:
a vehicle-mounted photographing device, mounted in a driving region of a vehicle, configured to capture a driving video of a vehicle during a driving process; and
a vehicle-mounted display device, mounted in the driving region of the vehicle and/or a seating region of the vehicle, configured to perform rendering processing of effects on the driving video captured by the vehicle-mounted photographing device and display an effect video resulting from the rendering processing of effects, by using the video effect processing method according to any one of the preceding items.

In a fourth aspect, according to one or more embodiments of the present disclosure provide an electronic device, including: at least one processor and a memory;
the memory is configured to store computer-executable instructions;
the at least one processor is configured to execute the computer-executable instructions that stored in the memory, which causes the at least one processor to perform the video effect processing method according to any of the preceding items.

In a fifth aspect, one or more embodiments of the present disclosure provide a computer-readable storage medium, computer executable instructions are stored on the computer-readable storage medium, and the computer executable instructions, when executed by a processor, implement the video effect processing method according to any one of the preceding items.

In a sixth aspect, one or more embodiments of the present disclosure provide a computer program product, instructions are stored on the computer program product, and the instructions, when executed by a processor, implement the video effect processing method according to any of the preceding items.

In a seventh aspect, one or more embodiments of the present disclosure provide a computer program, the computer program, when executed by a processor, implements the video effect processing method according to any of the preceding items.

The foregoing description is merely the preferred embodiments of the present disclosure and illustrative of the principles of the technology employed. It should be understood by those skilled in the art that the scope of the disclosure involved in the present disclosure is not limited to the technical solution formed by the specific combination of the above technical features, but also covers other technical solutions formed by any combination of the above technical features or their equivalent features without departing from the concept of the above disclosure. For example, the above-described features can be substituted with the technical features disclosed in the present disclosure (but not limited to) having similar functions.

Further, while operations are depicted in a particular order, this should not be understood as requiring that these operations be performed in the particular order shown or in sequential order. In certain circumstances, multitasking and parallel processing may be advantageous. Likewise, while several specific implementation details are contained in the above discussion, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

1. A video effect processing method, comprising:
performing, during a driving process of a vehicle, target recognition processing based on at least two algorithms on a captured driving video, and performing target tracking processing on a result of the target recognition processing, to obtain a target to be rendered of the driving video as well as a corresponding image trajectory; and
performing rendering processing on the driving video according to an image trajectory of the target to be rendered in the driving video, and displaying an effect video resulting from the rendering processing of effects.

2. The method according to claim 1, wherein the driving video comprises a plurality of video frames in succession;
performing the target recognition processing based on the at least two algorithms on the captured driving video, and performing the target tracking processing on the result of the target recognition processing, to obtain the target to be rendered of the driving video as well as the corresponding image trajectory, comprises:
adopting, according to a frame number of the current video frame, a target recognition processing algorithm corresponding to the frame number to perform target recognition on the current video frame of the driving video, to obtain a target recognition box of the current video frame;
predicting an actual position of the target to be rendered in the current video frame according to a historical image trajectory of each of the target to be rendered in the driving video, to obtain a predicted position of the target to be rendered in the current video frame; and
performing matching processing on the target recognition box of the current video frame and the predicted position of the target to be rendered in the current video frame, and obtaining the actual position of the target to be rendered in the current video frame according to a result of the matching processing.

3. The method according to claim 2, wherein adopting, according to the frame number of the current video frame, the target recognition processing algorithm corresponding to the frame number to perform the target recognition on the current video frame of the driving video, to obtain the target recognition box of the current video frame, comprises:
in response to the current video frame being a 1st frame in the driving video, or the current video frame is a (1+nR)-th frame in the driving video, invoking a target detection algorithm to perform the target recognition processing on the current video frame to obtain the target recognition box of the current video frame;
wherein n and R are both positive integers, and R is a frame interval coefficient.

4. The method according to claim 2, wherein adopting, according to the frame number of the current video frame, the target recognition processing algorithm corresponding to the frame number to perform the target recognition on the current video frame of the driving video, to obtain the target recognition box of the current video frame, comprises:
in response to the current video frame being not a 1st frame of the driving video and the current video frame is not a (1+nR)-th frame in the driving video, invoking an optical flow prediction algorithm to perform the target recognition processing on the current video frame to obtain the target recognition box of the current video frame;
wherein n and R are both positive integers, and R is a frame interval coefficient.

5. The method according to claim 4, wherein invoking the optical flow prediction algorithm to perform the target recognition processing on the current video frame to obtain the target recognition box of the current video frame, comprises:
performing sparse optical flow prediction on a position in the current video frame of a target recognition box in a video frame previous to the current video frame, to obtain the target recognition box of the current video frame.

6. The method according to claim 3, further comprising:
adjusting a value of R for a result of the matching processing obtained by performing the matching processing on the target recognition box of the current video frame and the predicted position of the target to be rendered in the current video frame.

7. The method according to claim 2, wherein performing the matching processing on the target recognition box of the current video frame and the predicted position of the target to be rendered in the current video frame, comprises:
performing a first matching processing based on a degree of spatial overlap on the target recognition box of the current video frame and the predicted position of the target to be rendered in the current video frame;
in response to a processing result of the first matching processing being matched, taking the processing result of the first matching processing as the result of the matching processing;
in response to the processing result of the first matching processing being not matched, performing a second matching processing based on feature similarity on the target recognition box of the current video frame and the predicted position of the target to be rendered in the current video frame, and taking a processing result of the second matching processing as the result of the matching processing.

8. The method according to claim 1, wherein performing the rendering processing on the driving video according to the image trajectory of the target to be rendered in the driving video, comprises:
invoking a video effect rendering algorithm to process the target to be rendered in the driving video, to obtain the effect video.

9. The method according to claim 1, further comprising:
uploading the driving video and/or the effect video to cloud for storage in response to a first operation triggered by a user.

10. The method according to claim 1, further comprising:
transmitting the effect video to other users in response to a second operation triggered by a user.

11. A video effect processing apparatus, comprising:
a rendering module, configured to perform, during a driving process of a vehicle, target recognition processing based on at least two algorithms on a captured driving video, and performing target tracking processing on a result of the target recognition processing, to obtain a target to be rendered of the driving video as well as a corresponding image trajectory; and
configured to perform rendering processing on the driving video according to an image trajectory of the target to be rendered in the driving video; and
a display module, configured to display an effect video resulting from the rendering processing of effects.

12. A video effect processing system, comprising:
a vehicle-mounted photographing device, mounted in a driving region of a vehicle, configured to capture a driving video of a vehicle during a driving process; and
a vehicle-mounted display device, mounted in the driving region of the vehicle and/or a seating region of the vehicle, configured to perform rendering processing of effects on the driving video captured by the vehicle-mounted photographing device and display an effect video resulting from the rendering processing of effects, by using the video effect processing method according to claim 1.

13. An electronic device, comprising:
at least one processor; and
a memory;
the memory is configured to store computer-executable instructions;
the at least one processor is configured to execute the computer-executable instructions that stored in the memory, which cause the at least one processor to:
perform, during a driving process of a vehicle, target recognition processing based on at least two algorithms on a captured driving video, and performing target tracking processing on a result of the target recognition processing, to obtain a target to be rendered of the driving video as well as a corresponding image trajectory; and
perform rendering processing on the driving video according to an image trajectory of the target to be rendered in the driving video, and display an effect video resulting from the rendering processing of effects.

14. A computer-readable storage medium, wherein computer executable instructions are stored on the computer-readable storage medium, and the computer executable instructions, when executed by a processor, implement the video effect processing method according to claim 1.

15-16. (canceled)

17. The method according to claim 4, further comprising:
adjusting a value of R for a result of the matching processing obtained by performing the matching processing on the target recognition box of the current video frame and the predicted position of the target to be rendered in the current video frame.

18. The method according to claim 5, further comprising:
adjusting a value of R for a result of the matching processing obtained by performing the matching processing on the target recognition box of the current video frame and the predicted position of the target to be rendered in the current video frame.

19. The electronic device according to claim 13, wherein the driving video comprises a plurality of video frames in succession;
the computer-executable instructions further cause the at least one processor to:
perform the target recognition processing based on the at least two algorithms on the captured driving video, and performing the target tracking processing on the result of the target recognition processing, to obtain the target to be rendered of the driving video as well as the corresponding image trajectory, comprises:
adopt, according to a frame number of the current video frame, a target recognition processing algorithm corresponding to the frame number to perform target recognition on the current video frame of the driving video, to obtain a target recognition box of the current video frame;
predict an actual position of the target to be rendered in the current video frame according to a historical image trajectory of each of the target to be rendered in the driving video, to obtain a predicted position of the target to be rendered in the current video frame; and
perform matching processing on the target recognition box of the current video frame and the predicted position of the target to be rendered in the current video frame, and obtain the actual position of the target to be rendered in the current video frame according to a result of the matching processing.

20. The electronic device according to claim 13, wherein the computer-executable instructions further cause the at least one processor to:
invoke a video effect rendering algorithm to process the target to be rendered in the driving video, to obtain the effect video.

21. The electronic device according to claim 13, wherein the computer-executable instructions further cause the at least one processor to:
upload the driving video and/or the effect video to cloud for storage in response to a first operation triggered by a user.

22. The electronic device according to claim 13, wherein the computer-executable instructions further cause the at least one processor to:
transmit the effect video to other users in response to a second operation triggered by a user.
